(19) United States
(12) Patent Application Publication
(10) Pub. No.: US 2012/0056425 A1
(43) Pub. Date: Mar. 8, 2012

(54) STAND ALONE OPERATION SYSTEM FOR USE WITH UTILITY GRADE SYNCHRONOUS WIND TURBINE GENERATORS

(75) Inventor: Kevin L. Cousineau, Lompoc, CA (US)

(73) Assignee: Clipper Windpower, Inc.

(21) Appl. No.: 12/874,416

(22) Filed: Sep. 2, 2010

(51) Int. Cl. H02P 9/04

(52) U.S. Cl. 290/44

(57) ABSTRACT

Methods and system are provided for operating an energy producing device when a utility grid is unavailable. The energy producing device includes a power system receiving power from a generator of the energy producing device. The power system includes a main power component and an accessory power component, where the received power is provided to the main power component and accessory power component depending upon the availability of the utility grid. The main power component provides the received power to the utility grid and the accessory power component provides power to accessories of the energy producing device, wherein the power includes the received power and power from an energy storage device included within the accessory power component.

### BACKGROUND

The present exemplary embodiments relate generally to energy producing devices. They find particular application in conjunction with the operation of a wind turbine during periods when the utility grid is unavailable, and will be described with particular reference thereto. However, it is to be appreciated that the present exemplary embodiments are also amenable to other like applications.

At present, due to the asynchronous nature of wind turbine generators, there are few methods of operating a wind turbine and/or a wind farm during periods when the utility grid is absent. Despite the more recent use of synchronous generators, all wind utility grade wind turbine require accessory power for their operation and that power comes from the utility itself during periods of low wind speed activity. Consequently, if the utility grid is unavailable, wind turbines are unable to operate as independent electrical generators. This may include initializing operation and/or maintaining existing operation.

Most modern, utility grade, wind turbines are designed to operate for only a few milliseconds to a few seconds after the loss of the utility interconnect voltage. They accomplish this through energy storage reservoirs including batteries, capacitors and air pressure accumulators, but any operation beyond 3 to 5 seconds results is a normal shut down of the turbine itself.

The utility grid may be unavailable for any number of reasons. For example, a wind turbine may be built in a remote area, such as off shore, or a storm may temporarily interrupt power. As another example, a wind turbine may be built in an area having a utility grid unstable enough to handle the increased load the wind turbine places upon it. In such a scenario, at best the wind turbine can operate at partial capacity.

Traditional solutions to the foregoing problems involve renting diesel generators and using them to provide the necessary power. In most situations, this provides a reasonable, although not necessarily ideal or practical solution. A diesel generator to wind turbine generator interface requires a resistive load bank in order to allow proper operation of the turbine. This makes for a complex and expensive power plant and takes away much of the renewable energy advantage of the wind turbine itself. However, even so, there remain situations where it is not practical to rent generators or provide for their fuel requirements for long periods of time. For example, for an ocean-based wind farm, the logistics of moving the generators to the necessary locations may be daunting to say nothing about their expense. As another example, during the commissioning of a wind farm, if the utility grid is unavailable, problems often arise due to the scarcity of diesel generators. Further, the logistics involved with maintaining and fueling the large number of generators adds great inefficiency and cost to the overarching process of commissioning a wind farm.

The present disclosure contemplates new and improved systems and/or methods for initializing and maintaining normal operation of a wind turbine during periods when the utility grid is unavailable.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

According to one aspect of the present disclosure, an energy producing device is provided capable of operating during periods when a utility grid is unavailable. The energy producing device includes the wind turbine generator itself provisioned to generate power. Further, the energy producing device includes a power system. The power system includes a main power system and an accessory power component. The power system provides power generated by the wind turbine generator to the main power component when the utility grid is available and a combination of this same wind turbine generator and/or an accessory power component when the utility grid is unavailable. The accessory power component includes an energy storage device and a photovoltaic energy charging system and both provide power for the accessories load via a combination of their own storage and/or the wind turbine generator itself when the utility grid is unavailable.

According to another aspect of the present disclosure, a power system for an energy producing device is provided capable of operating the energy producing device's accessory power loads when a utility grid is unavailable. The power system receives power from the generator of the energy producing device and includes a main power component and an accessory power component. The main power component is provisioned to provide the received power to the utility grid when the utility grid is available and the accessory power component is provisioned to provide power to accessory loads of the energy producing device when the utility grid is unavailable. The power system further includes a switch for selectively providing the received power to one of the main power component and the accessory power component depending upon the availability of the utility grid.

According to another aspect of the present disclosure, a method is provided for operating an energy producing device when a utility grid is unavailable. The energy producing device includes a generator that converts wind power into generated power. Power generated by the generator is provided to one of a main power component and an accessory power component based upon availability of the utility grid. The method includes determining the availability of the utility grid, and, based upon this determination, the generated power is either provided to the accessory power component or the main power component, where the power is provided to the accessory power component when the utility grid is unavailable. When the utility grid is unavailable, accessories of the energy producing device are powered with the accessory power component. The accessory power component includes an energy storage device and the accessories are powered via the energy storage device and/or the generated power. When the utility grid is available, the accessories of the energy producing device are powered with the utility grid.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a schematic side view of a typical generally horizontal-axis “front running” wind turbine;

FIG. 2 is a detailed view of a power system suitably employed within the wind turbine of FIG. 1; and

FIG. 3 is block diagram of a method of operating a wind turbine when a utility grid is unavailable.

### DETAILED DESCRIPTION

The following disclosure provides systems and methods for operating a wind turbine during periods when the utility grid is unavailable. Namely, the systems and methods provide means for powering the accessories necessary for normal operation of the wind turbine. Accessories include, but are not limited to, controllers, sensors, pitch and azimuth systems, hydraulic systems, heating systems, signaling devices, obstruction lights for ships and aircraft, and the like.

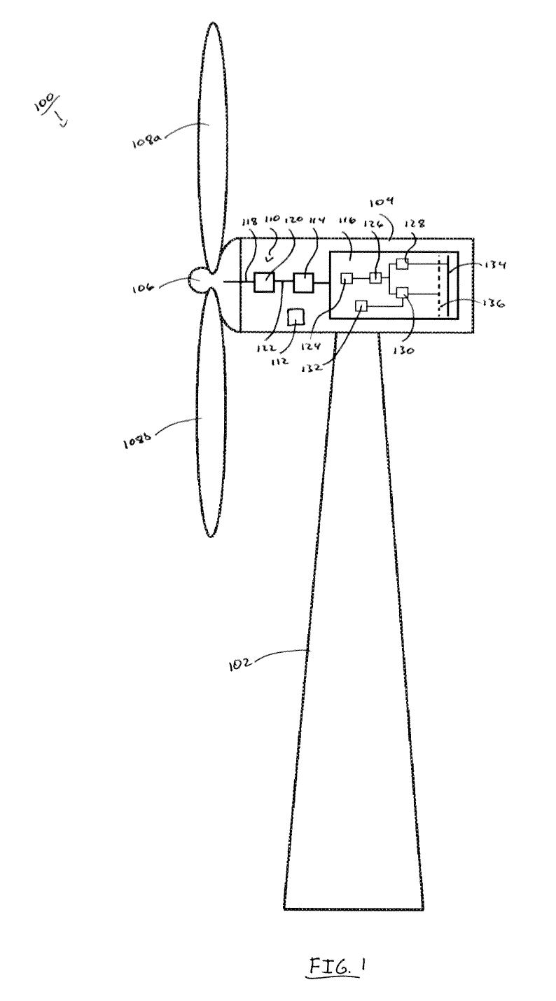

With reference to FIG. 1, a schematic side view of a typical generally horizontal-axis-, up wind, type of wind turbine 100 is illustrated. Of course, other known types of energy generating devices, such as ocean current turbines or other known types of wind turbines could similarly be provided with the disclosed power system. The wind turbine 100 includes a tower 102, a machine nacelle 104, a hub or rotor 106, one or more rotor blades 108 and a pitch system (not shown). The machine nacelle 104 is mounted at the top end of the tower 102, and the hub or rotor 106, bearing the one or more rotor blades 108, is mounted to a lateral end of the machine nacelle 104.

The rotor blades 108 can be adjusted by the pitch system, which is typically accommodated inside the hub 106. The pitch system generally includes pitch drives for adjusting the pitch of the blades. Further, for purposes of safety, the pitch system generally includes a pitch battery for each individual blade, thereby allowing the rotor blades 108 to be adjusted even during periods of power loss.

The machine nacelle 104 houses many of the accessories needed for maintaining normal operation of the wind turbine 100. Namely, disposed within the machine nacelle 104, the wind turbine 100 typically includes a drive train 110, a yaw motor (not shown), a main controller 112, a main generator 114, and a main power system 116.

The drive train 110 transfers the mechanical energy of the rotor 106 to the main generator 114 and typically includes a driveshaft 118. Additionally, the drive train 110 may include a gearbox 120, as shown, for transforming the rotational speed of the driveshaft 118, which is typically coupled to the rotor 106, to a higher value of a high speed shaft 122, which is typically coupled to the main generator 114.

The main controller 112 controls the operation of the wind turbine 100. Namely, the main controller 112 keeps the wind turbine 100 pointed into the wind so as to maximize efficiency. Further, the main controller 112 monitors line voltage from the utility grid. Advantageously, this allows the main controller 112 to detect the unavailability of the utility grid. As will be seen, in certain embodiments, when the unavailability of the utility grid is detected, the main controller 112, instead of entering an emergency exit power down mode, switches to an accessory power component 130, as discussed below.

The main generator 114 is suitably synchronous and converts the mechanical energy of the rotor 106 into electrical energy. The main generator 114 typically delivers electrical power which can be fed into the utility grid up to a rated generator output power. The rated output power of the main generator 114 is typically larger than 500 kVA and may be even larger than 1 MVA.

The power system 116 provides the necessary power to the accessories comprising, and maintaining operation of, the wind turbine 100. Further, the power system 116 provides power generated by the main generator 114 to the utility grid when possible. The power system 116 receives power from the output of the main generator 114 and includes a rectifier 124, a switch 126, a main power component 128, the auxiliary power system 130 and a charging system 132.

The output of the main generator 114 is electrically coupled to the rectifier 124 and the rectified output of the rectifier 124 is electrically coupled to the main power component 128 and the accessory power component 130 via the switch 126. The switch 126 switches between the main power component 128 and the accessory power component 130 depending upon the availability of the utility grid. Namely, in situations where the utility power is unavailable, the switch 126 selects the accessory power component 130, and, in situations where utility power is available, the switch 126 selects the main power component 128.

Under certain embodiments, the main controller 112 controls the switch 126. The main controller 112 detects a power outage by continuously monitoring line voltage of the utility grid. Advantageously, such a detection method requires no additional equipment other than that normally used for operation of a wind turbine. Alternatively, in other embodiments, other components of the wind turbine 100 having the ability to detect the availability of the utility grid may control the switch 126.

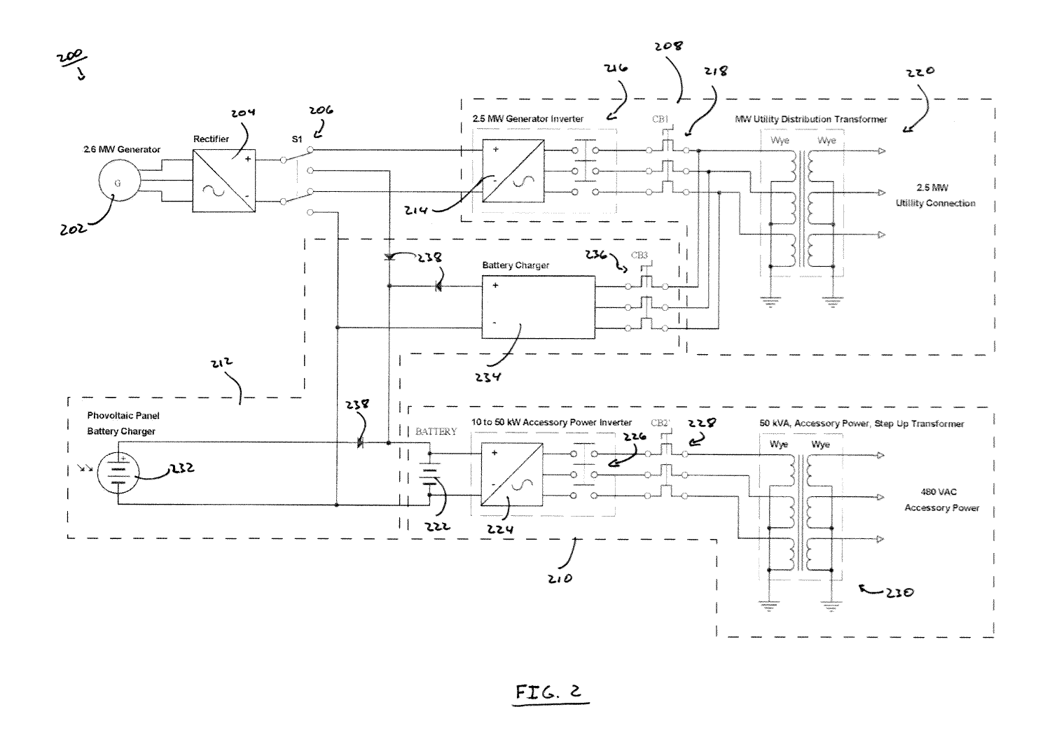

The main power component 128 typically converts the rectified output of the main generator 114 to an electrical power which can be fed into the utility grid. Power is fed into the utility grid via a first power line 134. The main power component 128 includes a power converter, such as a power converter 224 of FIG. 2, and, in certain embodiments, a transformer, such as a transformer 220 of FIG. 2. The term “power converter” as used herein refers to one or more active devices that convert an electric input power into a different electric output power and control the power conversion. This includes, but is not limited to, DC converters for changing the voltage and/or the current, AC-to-DC converters, DC-to-AC converters, and the like.

The accessory power component 130 typically converts the rectified output of the main generator 114 to an electrical power that is lower than the output power of the main power component 128 and suitable for use in powering the accessories necessary to maintain normal operation of the wind turbine 100. Power is provided to the accessories via a second power line 136. The accessory power component 130 includes a power converter, such as a power converter 224 of FIG. 2, and an energy storage device, member or item, such as a battery 222 of FIG. 2. Further, in certain embodiments, the power system 130 may include a transformer, such as a transformer 230 of FIG. 2.

The energy storage device provides power to the accessories of the wind turbine 100 necessary for maintaining normal operation during initialization and during periods when there is not enough wind to power the accessories with the main generator 114. Namely, during initialization of the wind turbine 100, the main generator 114 is not converting wind power to electrical power, whereby the energy storage device is generally the sole source of power. Further, during situations where the wind insufficient to power the accessories via the main generator 114, the energy storage device supplements power generated by the main generator 114.

Suitably, the energy storage device can be a battery, a capacitor, a flywheel or an accumulator or other energy storage device which is housed external to the hub 106 in the nacelle 104. Further, the energy storage device is separate and distinct from the pitch batteries discussed above. Doing otherwise could compromise the safety of the pitch system, since running accessories on the pitch system reduces the strength of the pitch batteries. Further, the pitch batteries are usually mounted in the rotating frame and as such their power would only be available through a series of slip rings to the nacelle. Most wind turbine provide AC power to the pitch systems that is rectified and used to charge these batteries. Providing DC power back through the slip ring to the nacelle is possible but somewhat unpractical due to the increase in slip rings required and the higher possibility of failure and discharge of the safety critical pitch batteries.

The charging system 132 maintains the energy storage device of the accessory power component 130 in a ready state. In certain embodiments, the charging system 132 includes an AC charger, such as an AC charger 234 of FIG. 2, powered by the main power component 128. These embodiments depend upon the existence of the utility grid to maintain the energy storage device in a ready state. In other embodiments, the charging system 132 includes a photovoltaic charger, such as a photovoltaic charger 232 of FIG. 2. As to such embodiments, the photovoltaic charger can be mounted on the top and/or sides of the machine nacelle 104. Alternatively, or in addition, the photovoltaic charger can be mounted on the tower 102.

With reference to FIG. 2, a detailed view is illustrated of one embodiment of a power system 200 suitably employed within the wind turbine 100 of FIG. 1. The power system 200 receives power from a main generator 202, which can be rated at 2.6 MW, and can be analogized to the main generator 114 of FIG. 1. Further, the power system 200 includes a rectifier 204, a switch 206, a main power component 208, an accessory power component 210 and a charger system 212.

The power system 200 receives power from the main generator 202 via the rectifier 204. The rectified output thereof is then passed to either the main power component 208 or the auxiliary power system 210 depending upon whether utility power is available. Namely, the rectified output passes to the main power component 208 when there is utility power and passes to the accessory power component 210 when there is no utility power. The switch 206 facilitates this selection between the main power component 208 and the accessory power component 210 and, as discussed above, is generally controlled by the main controller of a wind turbine.

The main power component 208 can include an inverter 214, switches 216, circuit breakers 218 and a transformer 220. The inverter 214 converts the rectified output of the rectifier 204 to AC power for purposes of interfacing with the utility grid. Consequently, the inverter 214 generates a frequency and phase in line with that of the utility grid. In the embodiment, the inverter 214 has a capacity of 2.5 MW. The output of the inverter 212 passes through the switches 216 and the circuit breakers 218 to the transformer 220. The switches 216 and circuit breakers 218 allow selective engagement of the main power component 208 and protect the main power component 208 against overload, respectively. The transformer 220 brings the output voltage of the inverter 214 in line with that of the utility grid to which the main power component 208 connects.

The accessory power component 210 includes a battery 222, an inverter 224, switches 226, circuit breakers 228, and a transformer 230. The inverter 224 receives a DC input from the rectifier 204 and/or the battery 222. The inverter 224 then converts the DC input to AC power for purposes of interfacing with accessories necessary to carry out normal operation of a wind turbine. Consequently, the inverter 224 generates a frequency and phase in line with that used by the accessories. As shown, the inverter 224 has a capacity of 10 to 50 kW. The output of the inverter 224 then passes through the switches 226 and the circuit breaker 228 to the transformer 230. The switches 226 and the circuit breaker 228 allow selective engagement of the accessory power component 208 and protect the accessory power component 208 against overload, respectively. The transformer 230 brings the output voltage of the inverter 224 in line with that required by the accessories.

The power contributed by the battery 222 varies on a sliding scale depending upon the power provided by the main generator 202. At one extreme, when the wind turbine to which the power system 200 belongs is first initializing, the main generator 202 is not providing any power and the battery 222 wholly powers the accessories. At the other extreme, when the wind turbine to which the power system 200 belongs is operating normally, the main generator 202 provides sufficient power to power the accessories and the battery 222 contributes nothing. The gray area between the abovementioned extremes occurs when the main generator 202 is not generating sufficient power to power the accessories because, for example, the wind is not strong enough. In these situations, the battery 222 supplements the power provided by the main generator 202.

The charging system 212 maintains the battery 222 in a ready state and can include a photovoltaic charger 232, an AC battery charger 234, diodes 236, and circuit breakers 238. All of the chargers 232, 234 are isolated using diodes so that they supply charge only to the battery 222 and cannot be discharged by each other.

The photovoltaic charger 232 maintains the battery 222 in a ready state regardless of the availability of utility power and may be mounted to the machine nacelle and/or the tower of the wind turbine. Further, the photovoltaic charger 232 supplements the battery 222 during periods of discharge (e.g., when the wind is slight or the wind turbine is being initialized). Since the power draw of accessories during periods of low wind and initialization is slight, the photovoltaic charger 232 can be small compared to the overall output capabilities of the inverter 224.

The AC charger 234 provides a charging voltage across the battery 222 similar to the photovoltaic charger 232. The AC charger 234 receives power from the main power component 208, whereby it is dependent upon the existence of utility power. The AC charger 234 includes an inverter (not shown) to convert the AC output of the inverter 214 of the main power component 208 to DC.

In addition to the charging system 212, the battery 222 also receives a charge from the main generator 202. Namely, when the main generator 202 is generating enough power for the accessories, the rectified output of the main generator 202 will generally be sufficient to charge the battery 222 in addition to powering the accessories. While this does not help charge the battery 222 during initialization of a wind turbine, it advantageously provides another source from which to charge the battery when the wind turbine is operating.

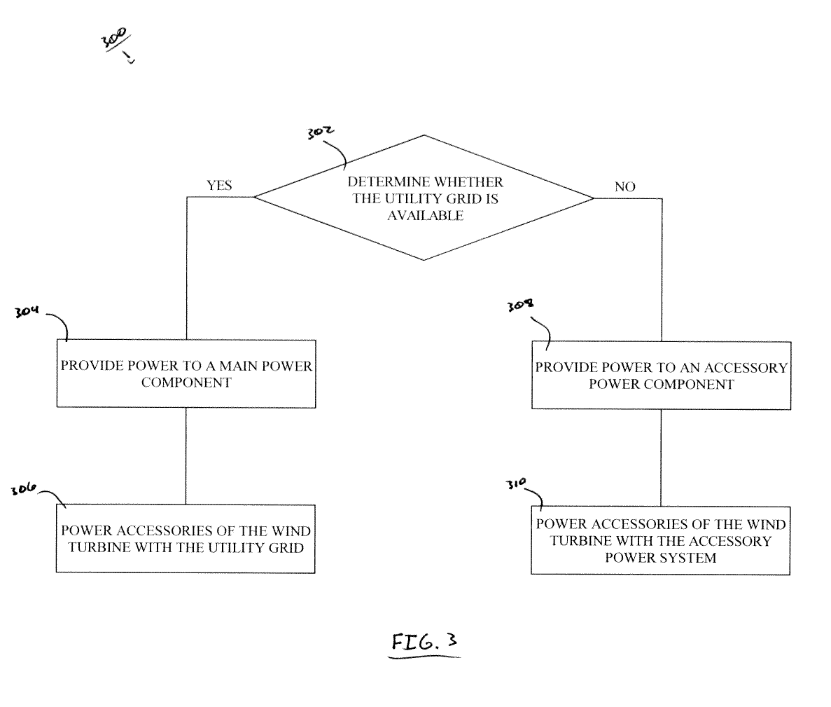

With reference to FIG. 3, a method 300 of operating a wind turbine during periods when a utility grid is unavailable is illustrated. Suitably, the wind turbine includes a main generator, such as the main generator 114 of FIG. 1. The method 300 initially determines the availability of the utility grid (Action 302). If the utility grid is determined to be available, power generated by the main generator of the wind turbine is provided to a main power component (Action 304). Additionally, accessories of the wind turbine are powered with the utility grid (Action 306). If the utility grid is determined to be unavailable, power generated by a main generator of the wind turbine is provided to an accessory power component (Action 308). Additionally, accessories of the wind turbine are powered with the accessory power component (Action 310).

The determining of the availability of the utility grid (Action 302) may be accomplished in any number of ways. Suitably, however, this is accomplished through the use of the main controller of the wind turbine. Namely, the main controller monitors line voltage from the utility grid and may be provisioned to determine the availability of the utility grid based upon the line voltage. This measurement may be based on what is measured at the Generator Converter (214 in FIG. 2) or an external transducer or other means.

The providing of power generated by the main generator of the wind turbine to the accessory power component when the utility grid is determined to be unavailable and to the main power component when the utility grid is determined to be available (Actions 304 and 308, respectively) is facilitated by Action 302's determination as to the availability of the utility grid. Namely, based upon the determination in Action 302, the power generated by the main generator is switched between the main power component and the accessory power component.

The powering of accessories of the wind turbine with the accessory power component when the utility grid is determined to be unavailable (Action 306) allows the operation of the wind turbine during periods when the utility grid is unavailable. Namely, the accessory power component includes an energy storage device and powers the accessories with the energy storage device and/or the generated power. The energy storage device supplements the generated power when the generated power is insufficient to power the accessories. Advantageously, the energy storage device allows operation of the wind turbine during periods when there is no generated power (e.g., during initialization of the wind turbine).

The powering of accessories of the wind turbine with the utility grid when the utility grid is determined to be available (Action 310) represents the behavior of typical wind turbines at all times. Namely, most wind turbines wholly depend upon the utility grid for powering accessories. As discussed above, this presents a number of challenges, thereby leading to the systems and/or methods disclosed herein.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. An energy producing device capable of operating during periods when a utility grid is unavailable, said energy producing device comprising:
a generator provisioned to generate power; and
a power system including a main power component and an accessory power component, wherein the power system provides power generated by the generator to the main power component when the utility grid is available and to the accessory power component when the utility grid is unavailable, wherein the accessory power component includes an energy storage device and powers the accessories with the energy storage device and/or the generated power when the utility grid is unavailable.

2. The energy producing device of claim 1, said system further comprising:
a main controller that measures line voltage from the utility grid, wherein the main controller determines availability of the utility grid based upon the line voltage, wherein the main controller controls which of the main power component and the accessory power component receives the generated power based upon this determination.

3. The energy producing device of claim 1, wherein the energy storage device provides power to the accessories while the generated power is insufficient to power the accessories and the utility grid is unavailable.

4. The energy producing device of claim 1, wherein the power system includes a charging system having at least one charger, wherein the charging system maintains the energy storage device in a charged state.

5. The energy producing device of claim 1, wherein the energy producing device comprises a wind turbine.

6. The energy producing device of claim 1, wherein the energy storage device is distinct from batteries included in a pitch system of the energy producing device.

7. The energy producing device of claim 1, wherein the power system includes a rectifier, wherein the rectifier rectifies the generated power and the rectified output thereof is provided to the main power component or the accessory power component.

8. The energy producing device of claim 1, wherein the accessories are comprised of components of the energy producing device necessary to operate the energy producing device.

9. A power system for an energy producing device capable of operating the energy producing device when a utility grid is unavailable, wherein said power system receives power from a generator of the energy producing device, said system comprising:
a main power component that provides the received power to the utility grid when the utility grid is available;
an accessory power component that provides power to accessories of the energy producing device when the utility grid is unavailable; and
a switch that selectively provides the received power to one of the main power component and the accessory power component depending upon the availability of the utility grid.

10. The power system of claim 9, wherein the accessory power component includes an energy storage device, wherein the energy storage device supplements the received power to provide sufficient power to the accessories of the energy producing device.

11. The power system of claim 10, further comprising:
a charging system including at least one charger, wherein the charging system maintains the energy storage device in a charged state.

12. The power system of claim 9, wherein the energy producing device comprises a wind turbine.

13. The power system of claim 9, further comprising:
a rectifier that rectifies the received power before it is provided to the one of the main power component and the accessory power component.

14. The power system of claim 9, wherein the accessories are comprised of components of the energy producing device necessary to operate the energy producing device.

15. A method of operating an energy producing device when a utility grid is unavailable, wherein the energy producing device includes a generator provisioned to generate power, said method comprising:
determining an availability of the utility grid;
providing the generated power to the accessory power component when the utility grid is determined to be unavailable;
providing the generated power to the main power component when the utility grid is determined to be available;
powering accessories of the energy producing device with the accessory power component when the utility grid is determined to be unavailable, wherein the accessory power component includes an energy storage device and powers the accessories with the energy storage device and/or the generated power; and
powering the accessories with the utility grid when the utility grid is determined to be available.

16. The method of claim 15, wherein the energy producing device comprises a wind turbine.

17. The method of claim 15, wherein the energy storage device provides power to the accessories when the generated power is insufficient to power the accessories and the utility grid is unavailable.

18. The method of claim 15, wherein the energy storage device is distinct from batteries included in a pitch system of the energy producing device.

19. The method of claim 15, wherein the generated power is rectified before being provided to the one of the main power component and the accessory power component.

20. The method of claim 15, wherein the accessories is comprised of components of the energy producing device necessary to operate the energy producing device.
